(19) United States
(12) Patent Application Publication
(10) Pub. No.: US 2023/0224895 A1
(43) Pub. Date: Jul. 13, 2023

(54) TERMINAL, RADIO COMMUNICATION METHOD, AND BASE STATION

(71) Applicant: NTT DOCOMO, INC., Tokyo (JP)

(72) Inventors: Yuki Matsumura, Tokyo (JP); Satoshi Nagata, Tokyo (JP); Jing Wang, Beijing (CN)

(73) Assignee: NTT DOCOMO, INC., Tokyo (JP)

(21) Appl. No.: 17/998,304

(22) PCT Filed: May 15, 2020
(86) PCT No.: PCT/JP2020/019553

§ 371 Date: Nov. 9, 2022

(51) Int. Cl. H04W 72/1268; H04W 72/23; H04L 5/00

(52) U.S. Cl. CPC H04W 72/1268; H04W 72/23; H04L 5/0051

(57) ABSTRACT

A terminal according to one aspect of the present disclosure includes: a reception section that receives a list including a plurality of path-loss reference signals (PL-RSs); and a control section that controls path-loss calculation by using a specific PL-RS for an uplink signal scheduled by downlink control information (DCI) including a sounding reference signal (SRS) resource indicator field, in a case where none of the plurality of PL-RSs is in an activated state.

### TECHNICAL FIELD

The present disclosure relates to a terminal, a radio communication method, and a base station in a next-generation mobile communication system.

### BACKGROUND ART

In a universal mobile telecommunications system (UMTS) network, specifications of long term evolution (LTE) have been drafted for the purpose of further increasing data rates, providing low latency, and the like (Non Patent Literature 1). Further, the specifications of LTE-Advanced (third generation partnership project (3GPP) Rel. 10 to 14) have been drafted for the purpose of further increasing capacity and advancement of LTE (3GPP Rel. 8 and 9).

Successor systems to LTE (for example, also referred to as 5th generation mobile communication system (5G), 5G+ (plus), 6th generation mobile communication system (6G), New Radio (NR), or 3GPP Rel. 15 and subsequent releases) are also being studied.

In the existing LTE systems (for example, 3GPP Rel. 8 to 14), a user terminal (user equipment (UE)) uses at least one of a UL data channel (for example, physical uplink shared channel (PUSCH)) or a UL control channel (for example, physical uplink control channel (PUCCH)) to transmit uplink control information (UCI).

### CITATION LIST

### Non Patent Literature

Non Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8)”, April 2010

### SUMMARY OF INVENTION

### Technical Problem

It has been studied that a user terminal (terminal or user equipment (UE)) uses a path-loss reference signal (PL-RS) for calculation of a path-loss for uplink (UL) transmit power control in a future radio communication system (e.g., NR).

It has been studied that a network (e.g., a base station) sets a plurality of PL-RSs (or PL-RS candidates) for the UE, and specifies a PL-RS to be activated from among the plurality of PL-RSs by using a medium access control-control element (MAC CE).

However, while the PL-RS is activated by the MAC control element, it is not clear which PL-RS is used by the UE to control the path-loss calculation. In a case where the PL-RS is not appropriately selected in the UE, UL transmission cannot be appropriately performed, and deterioration in system performance such as throughput decreases occurs.

Therefore, an object of the present disclosure is to provide a terminal that appropriately controls UL transmission using a path-loss reference signal, a radio communication method, and a base station.

### Solution to Problem

A terminal according to one aspect of the present disclosure includes: a reception section that receives a list including a plurality of path-loss reference signals (PL-RSs); and a control section that controls path-loss calculation by using a specific PL-RS for an uplink signal scheduled by downlink control information (DCI) including a sounding reference signal (SRS) resource indicator field, in a case where none of the plurality of PL-RSs is in an activated state.

### Advantageous Effects of Invention

According to one aspect of the present disclosure, it is possible to appropriately control UL transmission using the path-loss reference signal.

### BRIEF DESCRIPTION OF DRAWINGS

FIG. 1 is a diagram illustrating an example of a radio resource control (RRC) information element regarding a PL-RS of Rel. 15.

FIG. 2 is a diagram illustrating an example of an RRC information element regarding a PL-RS of Rel. 16.

FIG. 3 is a diagram illustrating an example in which uplink (UL) transmission is performed before activation of the PL-RS by a medium access control-control element (MAC CE).

FIG. 4 is a diagram illustrating an example of UL transmission control according to a first aspect.

FIG. 5 is a diagram illustrating an example of information regarding PUSCH power control by a sounding reference signal (SRS) resource indicator (SRI).

FIG. 6 is a diagram illustrating another example of the information regarding PUSCH power control by the SRI.

FIG. 7 is a diagram illustrating an example of a schematic configuration of a radio communication system according to one embodiment.

FIG. 8 is a diagram illustrating an example of a configuration of a base station according to one embodiment.

FIG. 9 is a diagram illustrating an example of a configuration of a user terminal according to one embodiment.

FIG. 10 is a diagram illustrating an example of a hardware configuration of the base station and the user terminal according to one embodiment.

### DESCRIPTION OF EMBODIMENTS

(TCI, Spatial Relation, and QCL)

In NR, it has been studied to control reception processing (e.g., at least one of reception, demapping, demodulation, and decoding) and transmission processing (e.g., at least one of transmission, mapping, precoding, modulation, and coding) in UE of at least one of a signal and a channel (expressed as a signal/channel) based on a transmission configuration indication state (TCI state).

The TCI state may represent that applied to downlink signals/channels. The TCI state applied to an uplink signal/channel may be expressed as a spatial relation.

The TCI state is information regarding a quasi-co-location (QCL) of the signal/channel, and may also be referred to as a spatial Rx parameter, spatial relation information, or the like. The TCI state may be configured in the UE for each channel or each signal.

The QCL is an index indicating a statistical property of a signal/channel. For example, a case where one signal/channel and another signal/channel have a QCL relation may mean that it is possible to assume that at least one of Doppler shift, Doppler spread, an average delay, a delay spread, and a spatial parameter (e.g., a spatial Rx parameter) is identical (in QCL with respect to at least one of these) between the plurality of different signals/channels.

Note that, the spatial Rx parameter may correspond to a reception beam of the UE (for example, a reception analog beam), and the beam may be specified based on spatial QCL. The QCL (or at least one element of QCL) in the present disclosure may be replaced with the spatial QCL (sQCL).

A plurality of types (QCL types) of QCL may be defined. For example, four QCL types A to D with different parameters (or parameter sets) that can be assumed to be identical may be provided. These parameters (which may be referred to as QCL parameters) are as follows:
QCL type A (QCL-A): Doppler shift, Doppler spread, average delay, and delay spread;
QCL type B (QCL-B): Doppler shift and Doppler spread;
QCL type C (QCL-C): Doppler shift and average delay; and
QCL type D (QCL-D): spatial Rx parameter.

It may be referred to as a QCL assumption for the UE to assume that a certain control resource set (CORESET), channel, or reference signal has a specific QCL (e.g., QCL type D) relation with another CORESET, channel, or reference signal.

The UE may determine at least one of a Tx beam (Tx beam) and a reception beam (Rx beam) of a signal/channel based on a TCI state of the signal/channel or the QCL assumption.

The TCI state may be, for example, information regarding the QCL of a target channel (in other words, a reference signal (RS) for the channel) and another signal (e.g., another RS). The TCI state may be configured (indicated) by higher layer signaling, physical layer signaling, or a combination thereof.

In the present disclosure, higher layer signaling may be, for example, any of RRC signaling, medium access control (MAC) signaling, broadcast information, and the like, or a combination thereof.

For example, a MAC control element (MAC CE), a MAC protocol data unit (PDU), or the like may be used for the MAC signaling. The broadcast information may be, for example, a master information block (MIB), a system information block (SIB), remaining minimum system information (RMSI), other system information (OSI), or the like.

The physical layer signaling may be, for example, downlink control information (DCI).

A channel for which a TCI state or spatial relation is configured (specified) may be, for example, at least one of a physical downlink shared channel (PDSCH), a physical downlink control channel (PDCCH), a physical uplink shared channel (PUSCH), or a physical uplink control channel (PUCCH).

Furthermore, an RS having a QCL relation with the channel may be, for example, at least one of a synchronization signal block (SSB), a channel state information reference signal (CSI-RS)), a measurement reference signal (sounding reference signal (SRS)), a tracking CSI-RS (also referred to as a tracking reference signal (TRS)), and a QCL detection reference signal (also referred to as a QRS).

The SSB is a signal block including at least one of a primary synchronization signal (PSS), a secondary synchronization signal (SSS), or a physical broadcast channel (PBCH). The SSB may be referred to as an SS/PBCH block.

The UE may receive, by higher layer signaling, configuration information (e.g., PDSCH-Config, tci-StatesToAddModList) including a list of information elements of the TCI state.

An information element of a TCI state configured by higher layer signaling (“TCI-state IE” of RRC) may include a TCI state ID and one or more pieces of QCL information (“QCL-Info”). The QCL Information may include at least one of information regarding the RS having the QCL relation (RS related information) and information indicating a QCL type (QCL type information). The RS related information may include information such as an index of the RS (e.g., an SSB index or a non-zero-power (NZP) CSI-RS resource identifier (ID)), an index of a cell where the RS is located, or an index of a bandwidth part (BWP) where the RS is located.

In NR Rel. 15, both an RS of QCL type A and an RS of QCL type D, or only the RS of QCL type A may be configured for the UE as a TCI state of at least one of the PDCCH or the PDSCH.

In a case where the TRS is configured as the RS of QCL type A, the TRS is different from the demodulation reference signal (demodulation reference signal (DMRS)) of the PDCCH or the PDSCH, and it is assumed that the same TRS is periodically transmitted for a long time. The UE can measure the TRS and calculate an average delay, a delay spread, and the like.

In the UE for which the TRS is configured as the RS of QCL type A in the TCI state of the DMRS of the PDCCH or the PDSCH, it can be assumed that parameters (the average delay, the delay spread, and the like) of QCL type A are the same between the DMRS of the PDCCH or the PDSCH and the TRS, and thus, the parameters (the average delay, the delay spread, and the like) of type A of the DMRS of the PDCCH or the PDSCH can be obtained from a measurement result of the TRS. When performing channel estimation of at least one of the PDCCH or the PDSCH, the UE can perform channel estimation with higher accuracy using the measurement result of the TRS.

The UE for which the RS of QCL type D is configured can determine a UE reception beam (spatial domain reception filter, UE spatial domain reception filter) by using the RS of QCL type D.

An RS of QCL type X in a TCI state may mean an RS in a QCL type X relation with (DMRS of) a certain channel/signal, and this RS may be referred to as a QCL source of QCL type X in the TCI state.

(Path-Loss RS)

The path-loss PL_{b,f,c}(q_{d}) [dB] in transmit power control of each of a PUSCH, a PUCCH, and an SRS is calculated by the UE by using the index q_{d} of a reference signal (an RS, or a path-loss reference RS (PathlossReferenceRS)) for a downlink BWP associated with the active UL BWP b of the carrier f of the serving cell c. In the present disclosure, the path-loss reference signal, the path-loss reference RS, the path-loss (PL)-RS, the index q_{d}, an RS used for path-loss calculation, and an RS resource used for path-loss calculation may be replaced with each other. In the present disclosure, calculation, estimation, measurement, and tracking may be replaced with each other.

The UE may control the path-loss (or transmit power) calculation in each UL channel/UL signal based on the path-loss reference signal (PL-RS) configured for each UL channel/UL signal. The PL-RS may be activated/updated by MAC control information (MAC CE) in a predetermined case.

The predetermined case may be a case where a plurality of PL-RSs (e.g., a plurality of PL-RS candidates or a list of PL-RSs) are configured (Case A) or a case where a default spatial relation/PL-RS is applied/configured (Case B).

In Case A, for example, the network may configure a plurality of PL-RSs for the UE by using a higher layer parameter (e.g., RRC), and specify a PL-RS to be activated from among the plurality of PL-RSs by using the MAC CE. The plurality of PL-RSs may be replaced with a plurality of PL-RS candidates or a list including a plurality of PL-RS candidates.

In addition, activation of up to a predetermined number (e.g., four) of PL-RSs may be supported by using the MAC CE. Up to a predetermined number of PL-RSs may be activated for each cell (or for each BWP), or up to a predetermined number of PL-RSs may be activated for each UL channel/UL signal.

The maximum number of PL-RSs that can be configured by RRC may depend on the UE capability. In a case where the maximum number of PL-RSs that can be configured by RRC is X, X or less PL-RS candidates may be configured by RRC, and a PL-RS may be selected by the MAC CE from among the configured PL-RS candidates. The maximum number of PL-RSs that can be configured by RRC may be 4, 8, 16, 64, or the like.

(Default TCI State/Default Spatial Relation/Default PL-RS)

In an RRC connection mode, both in a case where in-DCI TCI information (higher layer parameter TCI-PresentInDCI) is set to “enabled” and when no in-DCI TCI information is configured, if the time offset between the reception of DL DCI (DCI that schedules a PDSCH) and the corresponding PDSCH (the PDSCH scheduled by the DCI) is smaller than a threshold (timeDurationForQCL) (application condition: a first condition), in the case of non-cross-carrier scheduling, the TCI state (a default TCI state) of the PDSCH may be the TCI state of the lowest CORESET ID in the newest slot in an active DL BWP of the CC (of a specific UL signal). Otherwise, the TCI state of the PDSCH (default TCI state) may be a TCI state of the lowest TCI state ID of the PDSCH in the active DL BWP for the scheduled CC.

In Rel. 15, individual MAC CEs including an MAC CE for activation/deactivation of a PUCCH spatial relation and an MAC CE for activation/deactivation of an SRS spatial relation are required. The PUSCH spatial relation conforms to the SRS spatial relation.

In Rel. 16, at least one of the MAC CE for activation/deactivation of the PUCCH spatial relation or the MAC CE for activation/deactivation of the SRS spatial relation does not have to be used.

In FR2, when both the spatial relation and the PL-RS for the PUCCH are not configured (application condition: second condition), the default assumption of the spatial relation and the PL-RS (the default spatial relation and the default PL-RS) is applied to the PUCCH. In FR2, when both the spatial relation and the PL-RS for the SRS (SRS resource for the SRS or SRS resource corresponding to an SRS resource indicator (SRI) in DCI format 0_1 for scheduling the PUSCH) are not configured (application condition, second condition), the default assumption of the spatial relation and the PL-RS (the default spatial relation and the default PL-RS) is applied to the PUSCH and the SRS scheduled by DCI format 0_1.

When a CORESET is configured in the active DL BWP on the CC, the default spatial relation and the default PL-RS may be in a TCI state or QCL assumption of a CORESET having the lowest CORESET ID in the active DL BWP. When a CORESET is not configured in the active DL BWP on the CC, the default spatial relation and the default PL-RS may be in an active TCI state having the lowest ID of the PDSCH in the active DL BWP.

In Rel. 15, a spatial relation of a PUSCH scheduled by DCI format 0_0 follows a spatial relation of a PUCCH resource having a lowest PUCCH resource ID among active spatial relations of PUCCHs on the same CC. Even when no PUCCHs are transmitted on SCells, the network needs to update the PUCCH spatial relations on all SCells.

In Rel. 16, no PUCCH configuration is required for the PUSCH scheduled by DCI format 0_0. For the PUSCH scheduled by DCI format 0_0, when there is no active PUCCH spatial relation or no PUCCH resource on the active UL BWP in the CC (application condition, second condition), the default spatial relation and the default PL-RS are applied to the PUSCH.

Further, the above-mentioned threshold may be referred to as QCL time duration “timeDurationForQCL”, “threshold”, “threshold for offset between a DCI indicating a TCI state and PDSCH scheduled by the DCI”, “threshold-Sched-Offset”, a schedule offset threshold, a scheduling offset threshold, or the like.

(Transmit Power Control for PUSCH)

In a case where the UE is provided with a configuration of PUSCH power control (e.g., SRI-PUSCH-PowerControl) based on a sounding reference signal (SRS) resource indicator (SRI) and is provided with one or more PL-RS ID values, the UE may obtain mapping between a set of values for the SRI field in DCI format 0_1 and a set of PL-RS ID values from higher layer signaling (e.g., sri-PUSCH-PowerControl-Id in SRI-PUSCH-PowerControl). The UE may determine an RS resource index q_{d} from the PL-RS IDs mapped against SRI field values in DCI format 0_1 that schedules a PUSCH.

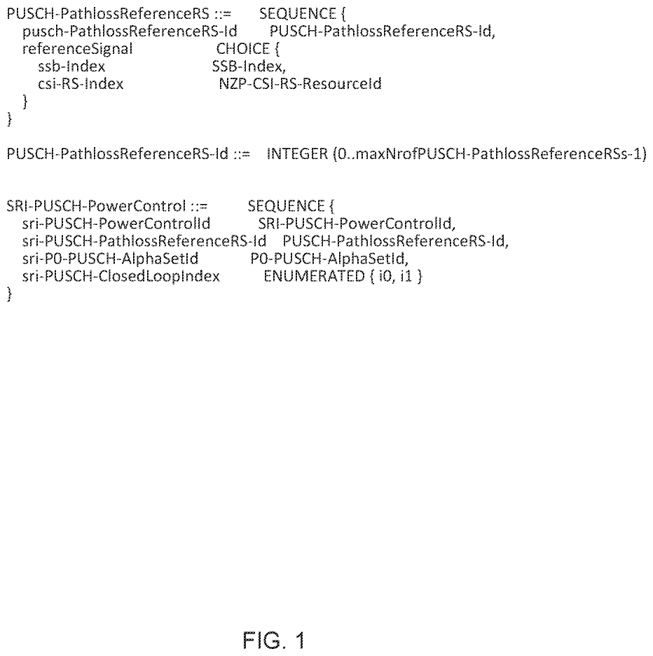

As illustrated in FIG. 1, in Rel. 15, a PL-RS (PUSCH-PathlossReferenceRS) including a PL-RS ID (PUSCH-PathlossReferenceRS-Id) and an RS is configured for a PUSCH by an RRC parameter.

In a case where the UE is provided with no PUSCH PL-RS (PUSCH-PathlossReferenceRS), or before the UE is provided with a dedicated higher layer parameter, the UE calculates PL_{b,f,c}(q_{d}) by using a reference signal (RS) resource from an SS/PBCH block that the UE uses to obtain a master information block (MIB).

PL_{b,f,c}(q_{d}) is, for example, a path-loss [dB] calculated by the UE by using index q_{d} of an RS (PL-RS) for a downlink BWP associated with the active UL BWP b of the carrier f of the serving cell c.

In a case where PUSCH transmission is scheduled by DCI format 0_0 and the UE is provided with no spatial setting for PUCH transmission, alternatively in a case where PUSCH transmission is scheduled by DCI format 0_1 including no SRI field, or alternatively in a case where no SRI-PUSCH power control information (SRI-PUSCH-PowerControl) is provided to the UE, the UE determines an RS resource index q_{d} having a respective PUSCH PL-RS ID (PUSCH-PathlossReferenceRS-Id) with a value equal to zero. Here, the RS resource is present on either serving cell c or a serving cell indicated by the value of PL-RS linking (pathlossReferenceLinkng) if provided.

For accurate path-loss measurement for transmit power control, in the UE of Rel. 15, up to a predetermined number of (e.g., four) PL-RSs are configured by RRC signaling.

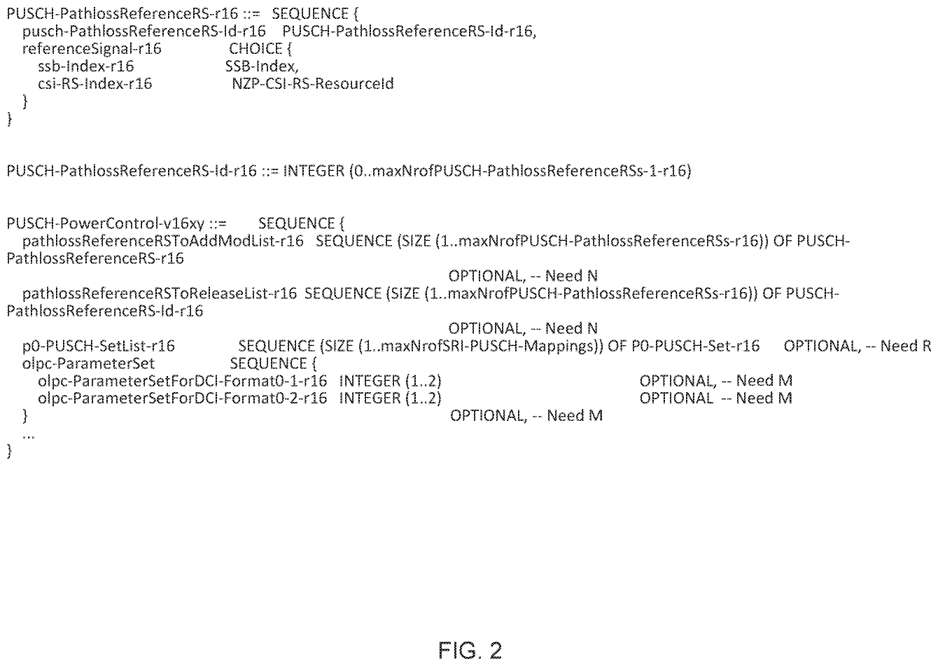

In Rel. 16, as illustrated in FIG. 2, for a PUSCH PL-RS, a PL-RS list (pathlossReferenceRSToAddModList-r16) is configured by an RRC parameter, and the PL-RS in the PL-RS list is activated by an MAC CE.

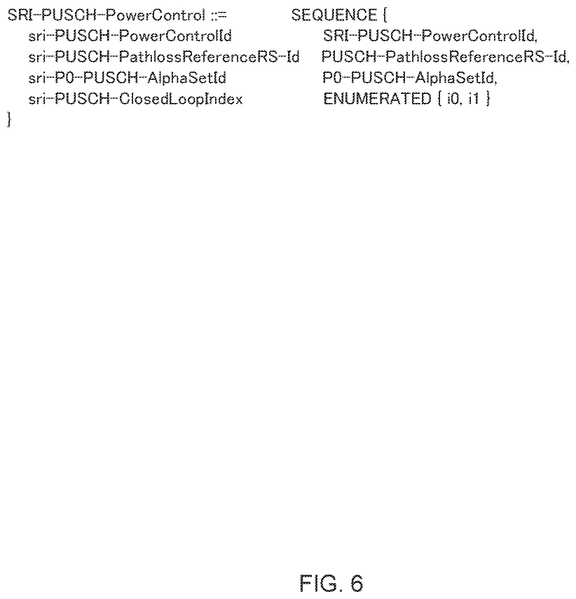

As illustrated in FIG. 6, in the UE of Rel. 16, up to 64 PL-RSs are configured by RRC signaling, and one PL-RS or up to a predetermined number of PL-RSs may be indicated (activated) by an MAC CE. The UE may be required to track up to four active PL-RSs for all UL channels (an SRS, a PUCCH, and a PUSCH). Tracking a PL-RS may be calculating a path-loss based on measurement of the PL-RS and retaining (storing) the path-loss.

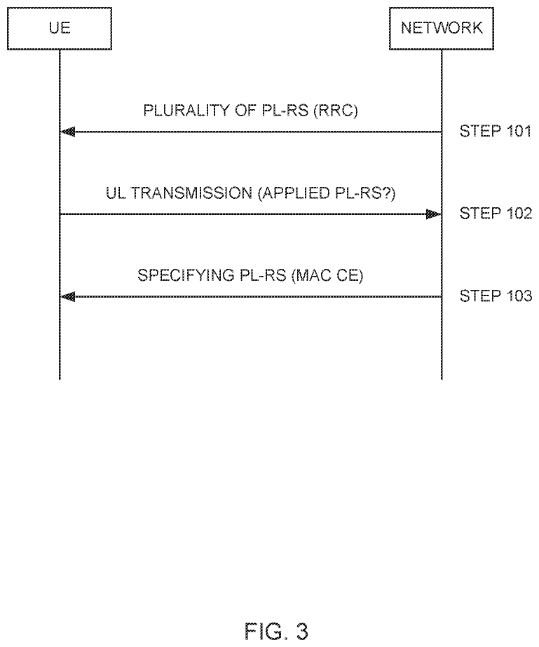

Meanwhile, a case where a plurality of PL-RSs are configured (Step 101), and UL transmission is performed/UL transmission is scheduled (Step 102) before a specific PL-RS (e.g., one or a predetermined number or less of PL-RSs) is activated by the MAC CE (Step 103) is also conceivable (see FIG. 3). In such a case, which PL-RS the UE selects becomes a problem. For example, in a case where a PUSCH is scheduled by a predetermined DCI format including the SRI field before a specific PL-RS is activated by the MAC CE (or in a case where there is no activated PL-RS for specifying with the SRI), how to determine the PL-RS to be applied to the PUSCH becomes a problem.

Alternatively, in a case where the default spatial relation/PL-RS is applied, and a corresponding TCI state is not activated by the MAC CE, how the UE determines the PL-RS becomes a problem.

The present inventors have focused on the fact that, in a case where a plurality of PL-RSs are configured, there is a state/period in which a specific PS-RS is not activated by the MAC CE, and have studied a method of determining a PL-RS in the state/period in which a specific PL-RS is not activated, and conceived the present embodiment.

Hereinafter, embodiments according to the present disclosure will be described in detail with reference to the drawings. Radio communication methods according to the respective embodiments may be applied independently, or may be applied in combination.

In the present disclosure, “A/B” and “at least one of A or B” may be interchangeable. In the present disclosure, the cell, the CC, the carrier, the BWP, and the band may be read as interchangeable with each other. In the present disclosure, an index, an ID, an indicator, and a resource ID may be read as interchangeable with each other. In the present disclosure, an RRC parameter, a higher layer parameter, an RRC information element (IE), and an RRC message may be read as interchangeable with each other.

In the present disclosure, a TCI state, a QCL assumption, a QCL parameter, a spatial domain reception filter, a UE spatial domain reception filter, a UE reception beam, a DL reception beam, a DL precoding, a DL precoder, a DL-RS, an RS of QCL type D of a TCI state or a QCL assumption, and an RS of QCL type A of a TCI state or a QCL assumption may be replaced with each other. In the present disclosure, the RS of QCL type D, the DL-RS associated with QCL type D, the DL-RS with QCL type D, a source of the DL-RS, the SSB, and the CSI-RS may be replaced with each other.

In the present disclosure, a spatial relation, spatial relation information, a spatial relation assumption, a QCL parameter, a spatial domain transmission filter, a UE spatial domain transmission filter, a UE Tx beam, a UL Tx beam, a UL precoding, a UL precoder, a spatial relation RS, a DL-RS, a QCL assumption, an SRI, a spatial relation based on an SRI, and a UL TCI may be replaced with each other.

In the present disclosure, DCI format 0_0, DCI including no SRI, DCI including no indication of a spatial relation, and DCI including no CIF may be replaced with each other. In the present disclosure, DCI format 0_1, DCI including an SRI, DCI including an indication of a spatial relation, and DCI including a CIF may be replaced with each other.

(First Aspect)

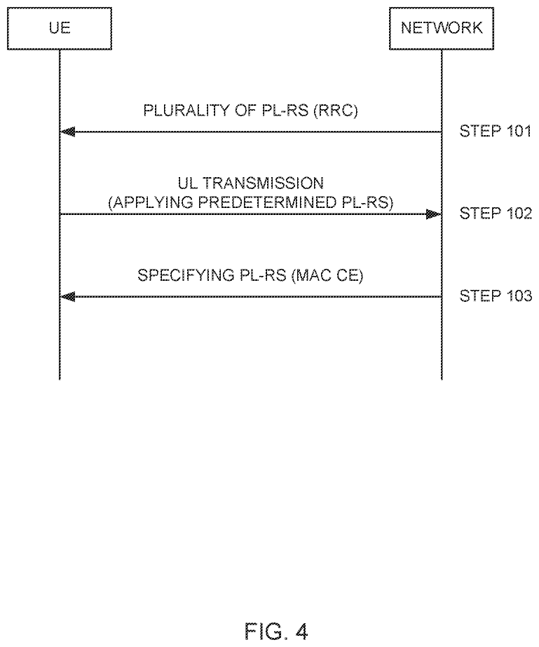

In a first aspect, a predetermined path-loss reference signal is used to control UL transmission (e.g., path-loss calculation) in a case/period in which a plurality of path-loss reference signals are configured for a predetermined UL channel/UL signal and none of the plurality of path-loss reference signals are activated by the MAC CE (see FIG. 4).

The plurality of path-loss reference signals (PL-RSs) may be replaced with a plurality of PL-RS candidates or a list of PL-RSs. The predetermined UL channel/UL signal may be at least one of a PUCCH, a PUSCH, or an SRS. The case/period in which the PL-RS activation is not made by the MAC CE may be any one of a period before receiving the MAC CE indicating the PL-RS activation, a period after receiving the MAC CE indicating deactivation of all the PL-RSs, and a case/period in which there is no PL-RS in an active state.

The predetermined PL-RS may be a specific PL-RS selected from a plurality of PL-RSs (Option 1-1). Alternatively, the predetermined PL-RS may be a specific reference signal (e.g., a synchronization signal block (e.g., SSB or SS/PBCH block)) (Option 1-2).

<Option 1-1>

The UE may apply, as the predetermined PL-RS, a PL-RS having the lowest index (alternatively, a PL-RS in a PL-RS list with the lowest index) among a plurality of PL-RSs configured using the higher layer parameter. Alternatively, the UE may apply, as the predetermined PL-RS, a PL-RS having the highest index (alternatively, a PL-RS in a PL-RS list with the highest index) among a plurality of PL-RSs configured using the higher layer parameter.

The number of predetermined PL-RSs may be one or a plural number not exceeding a predetermined number. In a case of selecting a plurality of PL-RSs, the plurality of PL-RSs may be selected in an index order.

Alternatively, the UE may select, as the predetermined PL-RS, one or more PL-RSs from a plurality of PL-RSs configured using the higher layer parameter. That is, in a case where activation of a specific PL-RS is not specified in the MAC CE, the UE may autonomously select a PL-RS from a PL-RS list configured by RRC to control path-loss calculation.

As a result, even when there is no PL-RS activated by the MAC CE (in a case where all the PL-RSs configured by RRC are in an inactive state), a PL-RS to be applied by the UE can be determined.

<Option 1-2>

In a case where a CORESET is configured in an active DL BWP in a certain CC as the predetermined PL-RS, the UE may apply a reference signal (e.g., the SSB or SS/PBCH block) corresponding to the QCL assumption of the CORESET.

In a case where a CORESET is not configured in an active DL BWP in a certain CC, and the TCI state of a PDSCH is not activated, a predetermined type (e.g., type D) of reference signal may be applied as the predetermined path-loss reference signal.

The predetermined type of reference signal may be a reference signal of type D having the lowest (or highest) index in a TCI state list configured in an active DL BWP in a certain CC.

Alternatively, the predetermined type of reference signal may be a reference signal of type D having the lowest (or highest) code point of DCI in a TCI state list configured in an active DL BWP in a certain CC. The code point of the DCI may be a code point specifying the TCI state. In addition, a TCI state candidate included in the TCI state list configured by RRC may be a predetermined value (e.g., the number may be eight, or a number that does not need to be specified by the MAC CE) or less.

In this way, by using the predetermined path-loss reference signal, even when no PL-RS is activated by the MAC CE, UL transmission (e.g., path-loss calculation) can be appropriately controlled.

(Second Aspect)

In a second aspect, a default spatial relation/path-loss reference signal is used to control UL transmission (e.g., path-loss calculation) in a case/period in which a plurality of PL-RSs are configured for a predetermined UL channel/UL signal and none of the plurality of PL-RSs are activated by the MAC CE.

The UE may apply the default spatial relation/PL-RS in a case where a PL-RS list is configured for a predetermined UL channel/UL signal and none of PL-RSs included in the list are activated by the MAC CE.

In a case where a default PL-RS is included in a plurality of PL-RSs configured by RRC, the UE may control UL transmission by using at least the default PL-RS. In this case, Option 1-2 in the first aspect may be applied.

On the other hand, in a case where the default PL-RS is not included in the plurality of path-loss reference signals configured by RRC, the UE may apply the following Option 2-1 or Option 2-2.

<Option 2-1>

The UE controls UL transmission by using one or more PL-RSs selected from the default PL-RS and the PL-RS list (or a plurality of PL-RSs included in the list) configured by RRC. That is, before a specific PL-RS is activated by the MAC CE, the UE needs to support the PL-RS list configured by RRC (or a plurality of PL-RSs included in the list) and the default PL-RS.

Which PL-RS is selected may be determined based on the index of the PL-RS, or may be determined autonomously by the UE. Alternatively, the default PL-RS may be preferentially selected. For example, in a case of selecting one PL-RS, the UE may select the default PL-RS. In a case of selecting a plurality of PL-RSs, the UE may select the default PL-RS and at least one PL-RS included in the plurality of PL-RSs configured by RRC.

<Option 2-2>

The UE may control not to apply the default PL-RS. In this case, it is sufficient if the UE controls UL transmission by using one or more PL-RSs selected from the PL-RS list (or a plurality of PL-RSs included in the list) configured by RRC. For example, Option 1-1 in the first aspect may be applied.

That is, before a specific path-loss reference signal is activated by the MAC control information, the UE does not need to support the path-loss reference signal list (or a plurality of path-loss reference signals included in the list) configured by RRC and the default path-loss reference signal.

(Third Aspect)

In a third aspect, a reference signal (e.g., SSB) for acquiring the master information block (e.g., MIB) is used to control UL transmission (e.g., path-loss calculation) in a case/period in which a plurality of PL-RSs are configured for a predetermined UL channel/UL signal and none of the plurality of PL-RSs is activated by the MAC CE.

The UE may control the path-loss calculation by using a reference signal resource corresponding to the SSB used to acquire the MIB under a predetermined condition. The predetermined condition may be any one of a case where a PL-RS of a PUSCH (PUSCH-PathlossReferenceRS) is not provided, a period before a PL-RS is provided by RRC, or a case where the UE is not provided with a PL-RS of a PUSCH for Rel. 16 (PUSCH-PathlossReferenceRS-r16) and a period before activation by the MAC CE.

(Variation 1)

In at least one of the first to third aspects, a PL-RS to be applied to PUSCH transmission (e.g., transmit power/path-loss calculation) may be determined based on at least one of a DCI format by which a UL signal (e.g., PUSCH) is scheduled and whether or not a predetermined field is included in the DCI format.

For example, it is assumed that a plurality of PL-RSs are configured by RRC (e.g., RRC configuration/re-configuration) and a specific PL-RS is activated/updated by the MAC CE. In this case, a PL-RS to be applied may be different between an UL signal (e.g., PUSCH) scheduled by a predetermined DCI format including the SRI field and other UL signals.

For example, before the PL-RS is activated by the MAC CE, the PL-RS to be applied to transmission of the UL signal (e.g., PUSCH) scheduled by the predetermined DCI format including the SRI field may be determined based on the first to third aspects. The predetermined DCI format may be, for example, at least one of DCI format 0_1 or DCI format 0_2.

As a result, in a case where the UL signal is scheduled by the predetermined DCI format including the SRI field, even when there is no PL-RS (or PL-RS specified by the SRI) activated by the MAC CE, a PL-RS to be applied by the UE can be determined.

On the other hand, in other cases, a reference signal resource index (q_{d}) in which a PL-RS ID value of a PUSCH (PUSCH-PathlossReferenceRS-Id) is equal to zero may be applied. The other cases may be a case where a PUSCH is scheduled by DCI format 0_0 or a case where a PUSCH is scheduled by DCI format 0 I/O 2 that does not include the SRI field.

In addition, in a period before a plurality of PL-RSs (or a PL-RS) are configured by RRC and a specific PL-RS is activated/updated by the MAC CE, the UE does not have to assume that a PUSCH is scheduled by the predetermined DCI format including the SRI field. In this case, during the period, control may be performed in such a way that the PUSCH is scheduled by DCI format 0_0 or a predetermined DCI format that does not include the SRI field.

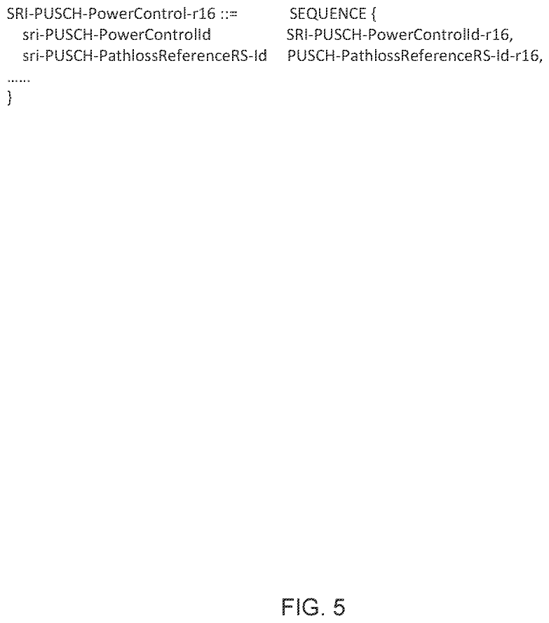

In addition, in a case where a plurality of PL-RSs (or PL-RS list) are configured by RRC, a correspondence (or default mapping) between an ID corresponding to configuration of PUSCH power control by the SRI (e.g., SRI-PUSCH-PowerControl) (e.g., SRI-PUSCH-PowerControlID-r16) and an ID of a PL-RS of a PUSCH (e.g., PUSCH-PathlossReferenceRS-Id-r16) may be configured (see FIG. 5).

The UE may determine the reference signal resource index (q_{d}) based on the lowest PUSCH-PathlossReferenceRS-ID (or PUSCH-PathlossReferenceRS-Id with a value equal to 0) in the list configured by RRC for PUSCH transmission scheduled by the predetermined DCI format including the SRI field before the mapping of SRI-PUSCH-PowerControlID and PUSCH-PathlossReferenceRS-Id is provided.

(Variation 2)

PUSCH power configuration by the SRI (e.g., sri-PUSCH-PowerControl) supported in the existing system (e.g., Rel. 15) may be made in the UE supporting Rel. 16 and subsequent releases. For example, even when the MAC CE is not transmitted after the PL-RS list is configured by RRC, at least one default mapping may be configured between sri-PUSCH-PowerControlID and PUSCH-PathlossReferenceRS-ID (see FIG. 6).

As a PL-RS for a PUSCH scheduled by the predetermined DCI format (e.g., DCI format 0_1/0_2), the UE may apply at least one of the following Options A to C.

<Option A>

The UE does not have to assume that a PUSCH is scheduled by a predetermined DCI format including a predetermined SRI field before activation by the MAC CE. The predetermined SRI field may be configured in such a way that an SRI index is not configured in association with PUSCH-PathlossReferenceRS-ID by RRC.

This may mean that, in a case where a PUSCH is scheduled by the predetermined DCI format including the SRI field, the SRI index included in the DCI needs to be an SRI index configured by sri-PUSCH-PowerControl to indicate mapping of the SRI index and PUSCH-PathlossReferenceRS-ID.

<Option B>

Alternatively, in a case where a PUSCH is scheduled by the predetermined DCI format including SRI field, and an SRI index included in the DCI is not configured in association with PUSCH-PathlossReferenceRS-ID by RRC before activation by the MAC CE, the UE may assume that the PL-RS is PUSCH-PathlossReferenceRS-ID corresponding to (or mapped to) sri-PUSCH-PowerControlID=0.

[Option C]

Alternatively, in a case where a PUSCH is scheduled by the predetermined DCI format including the SRI field before activation by the MAC CE, the UE may assume that the PL-RS is PUSCH-PathlossReferenceRS-ID corresponding to (or mapped to) sri-PUSCH-PowerControlID=0.

(Radio Communication System)

Hereinafter, a configuration of a radio communication system according to one embodiment of the present disclosure will be described. In this radio communication system, communication is performed using one or a combination of the radio communication methods according to the embodiments of the present disclosure.

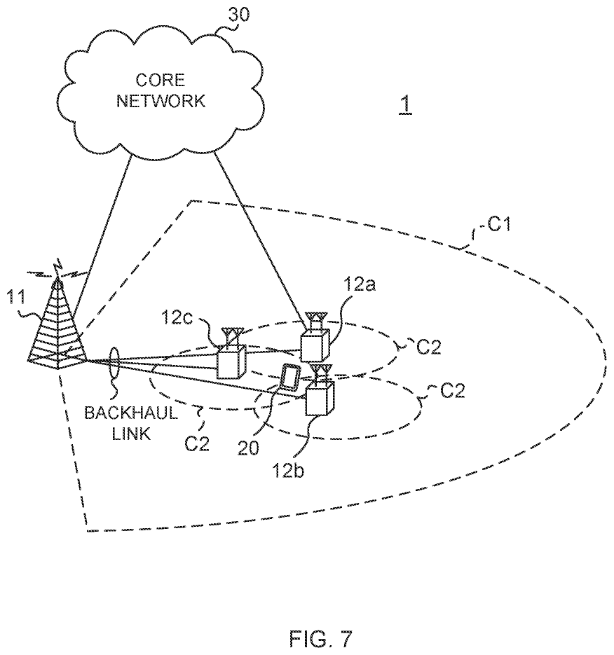

FIG. 7 is a diagram illustrating an example of a schematic configuration of the radio communication system according to one embodiment. A radio communication system 1 may be a system that implements communication using long term evolution (LTE), 5th generation mobile communication system New Radio (5G NR), and the like drafted as the specification by third generation partnership project (3GPP).

Furthermore, the radio communication system 1 may support dual connectivity (multi-RAT dual connectivity (MR-DC)) between a plurality of radio access technologies (RATs). The MR-DC may include dual connectivity between LTE (evolved universal terrestrial radio access (E-UTRA)) and NR (E-UTRA-NR dual connectivity (EN-DC)), dual connectivity between NR and LTE (NR-E-UTRA dual connectivity (NE-DC)), and the like.

In the EN-DC, an LTE (E-UTRA) base station (eNB) is a master node (MN), and an NR base station (gNB) is a secondary node (SN). In the NE-DC, an NR base station (gNB) is a MN, and an LTE (E-UTRA) base station (eNB) is an SN.

The radio communication system 1 may support dual connectivity between a plurality of base stations in the same RAT (e.g., dual connectivity in which both a MN and an SN are NR base stations (gNBs) (NR-NR dual connectivity (NN-DC)).

The radio communication system 1 may include a base station 11 that forms a macro cell C1 with a relatively wide coverage and base stations 12 (12a to 12c) that are arranged within the macro cell C1 and form small cells C2 narrower than the macro cell C1. A user terminal 20 may be positioned in at least one cell. The arrangement, number, and the like of cells and the user terminals 20 are not limited to the aspects illustrated in the drawings. Hereinafter, the base stations 11 and 12 will be collectively referred to as base stations 10 unless specified otherwise.

The user terminal 20 may be connected to at least one of the plurality of base stations 10. The user terminal 20 may use at least one of carrier aggregation (CA) using a plurality of component carriers (CCs) or dual connectivity (DC).

Each CC may be included in at least one of a first frequency range 1 (FR1) or a second frequency range 2 (FR2). The macro cell C1 may be included in FR1, and the small cell C2 may be included in FR2. For example, FR1 may be a frequency range of 6 GHz or less (sub-6 GHz), and FR2 may be a frequency range higher than 24 GHz (above-24 GHz). Note that the frequency ranges, definitions, and the like of FR1 and FR2 are not limited thereto, and, for example, FR1 may correspond to a frequency range higher than FR2.

Furthermore, the user terminal 20 may perform communication in each CC using at least one of time division duplex (TDD) or frequency division duplex (FDD).

The plurality of base stations 10 may be connected by wire (e.g., an optical fiber or an X2 interface in compliance with common public radio interface (CPRI)) or wirelessly (e.g., NR communication). For example, when NR communication is used as a backhaul between the base stations 11 and 12, the base station 11 corresponding to a higher-level station may be referred to as an integrated access backhaul (IAB) donor, and the base station 12 corresponding to a relay station (relay) may be referred to as an IAB node.

The base station 10 may be connected to a core network 30 via another base station 10 or directly. The core network 30 may include, for example, at least one of evolved packet core (EPC), 5G core network (5GCN), or next generation core (NGC).

The user terminal 20 may be a terminal supporting to at least one of communication methods such as LTE, LTE-A, and 5G.

In the radio communication system 1, a radio access method based on orthogonal frequency division multiplexing (OFDM) may be used. For example, in at least one of downlink (DL) or uplink (UL), cyclic prefix OFDM (CP-OFDM), discrete Fourier transform spread OFDM (DFT-s-OFDM), orthogonal frequency division multiple access (OFDMA), single carrier frequency division multiple access (SC-FDMA), and the like may be used.

The radio access method may be referred to as a waveform. Note that in the radio communication system 1, another radio access method (e.g., another single carrier transmission method or another multi-carrier transmission method) may be used as the UL and DL radio access method.

In the radio communication system 1, as downlink channels, a downlink shared channel (physical downlink shared channel (PDSCH)) that is shared by respective user terminals 20, a broadcast channel (physical broadcast channel (PBCH)), a downlink control channel (physical downlink control channel (PDCCH)), or the like may be used.

Furthermore, in the radio communication system 1, as uplink channels, an uplink shared channel (physical uplink shared channel (PUSCH)) that is shared by respective user terminals 20, an uplink control channel (physical uplink control channel (PUCCH)), a random access channel (physical random access channel (PRACH)), or the like may be used.

User data, higher layer control information, the system information block (SIB), and the like are transmitted on the PDSCH. The PUSCH may transmit the user data, higher layer control information, and the like. Furthermore, the master information block (MIB) may be transmitted on the PBCH.

Lower layer control information may be transmitted on the PDCCH. The lower layer control information may include, for example, downlink control information (DCI) including scheduling information of at least one of the PDSCH or the PUSCH.

Note that DCI that schedules the PDSCH may be referred to as DL assignment, DL DCI, or the like, and DCI that schedules the PUSCH may be referred to as UL grant, UL DCI, or the like. Note that the PDSCH may be replaced with DL data, and the PUSCH may be replaced with UL data.

A control resource set (CORESET) and a search space may be used to detect the PDCCH. The CORESET corresponds to a resource that searches for DCI. The search space corresponds to a search area and a search method for PDCCH candidates. One CORESET may be associated with one or more search spaces. The UE may monitor the CORESET associated with a certain search space based on search space configuration.

One search space may correspond to a PDCCH candidate corresponding to one or more aggregation levels. One or more search spaces may be referred to as a search space set. Note that “search space” and “search space set”, “search space configuration” and “search space set configuration”, and “CORESET” and “CORESET configuration”, and the like in the present disclosure may be replaced with each other.

Uplink control information (UCI) including at least one of channel state information (CSI), delivery acknowledgement information (which may be referred to as, for example, hybrid automatic repeat request acknowledgement (HARQ-ACK), ACK/NACK, or the like), or scheduling request (SR) may be transmitted on the PUCCH. A random access preamble for establishing connection with a cell may be transmitted on the PRACH.

Note that, in the present disclosure, downlink, uplink, and the like may be expressed without “link”. Furthermore, various channels may be expressed without adding “physical” at the beginning thereof.

In the radio communication system 1, a synchronization signal (SS), a downlink reference signal (DL-RS), and the like may be transmitted. In the radio communication system 1, a cell-specific reference signal (CRS), a channel state information reference signal (CSI-RS), a demodulation reference signal (DMRS), a positioning reference signal (PRS), a phase tracking reference signal (PTRS), and the like may be transmitted as DL-RSs.

The synchronization signal may be, for example, at least one of a primary synchronization signal (PSS) or a secondary synchronization signal (SSS). A signal block including the SS (PSS or SSS) and the PBCH (and the DMRS for the PBCH) may be referred to as an SS/PBCH block, an SS block (SSB), or the like. Note that the SS, the SSB, or the like may also be referred to as a reference signal.

Furthermore, in the radio communication system 1, a sounding reference signal (SRS), a demodulation reference signal (DMRS), and the like may be transmitted as an uplink reference signal (UL-RS). Note that, a DMRS may be referred to as a “user terminal-specific reference signal (UE-specific reference signal)”.

(Base Station)

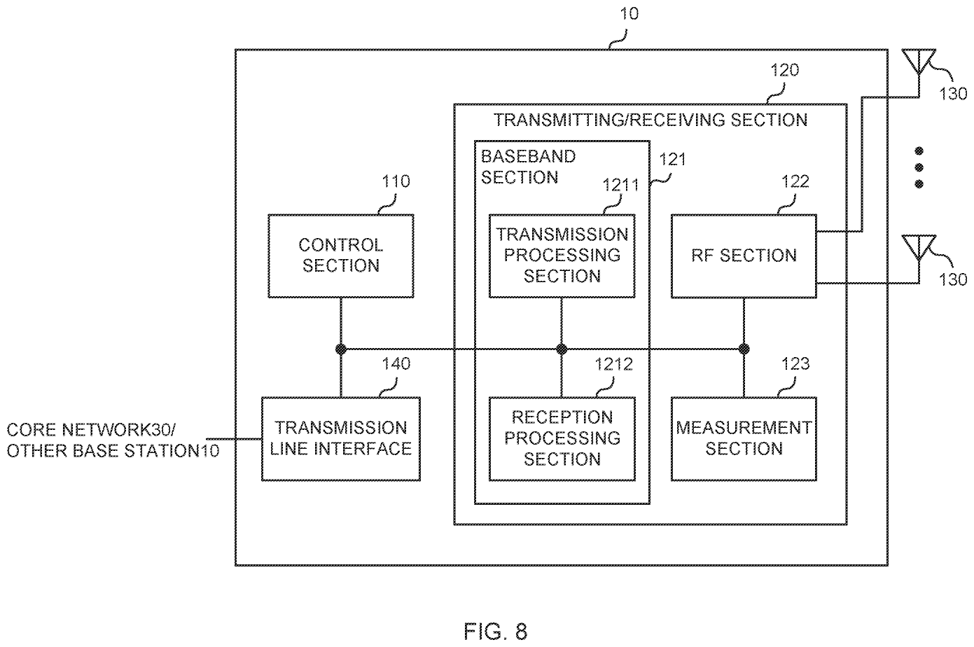

FIG. 8 is a diagram illustrating an example of a configuration of the base station according to one embodiment. The base station 10 includes a control section 110, a transmission/reception section 120, a transmitting/receiving antenna 130, and a transmission line interface 140. Note that one or more control sections 110, one or more transmission/reception sections 120, one or more transmitting/receiving antennas 130, and one or more transmission line interfaces 140 may be included.

Note that, although this example primarily indicates functional blocks of characteristic parts of the present embodiment, it may be assumed that the base station 10 has other functional blocks that are necessary for radio communication as well. A part of processing of each section described below may be omitted.

The control section 110 controls the entire base station 10. The control section 110 can be implemented by a controller, a control circuit, and the like that are described based on common recognition in the technical field related to the present disclosure.

The control section 110 may control signal generation, scheduling (e.g., resource allocation or mapping), and the like. The control section 110 may control transmission/reception, measurement, and the like using the transmission/reception section 120, the transmitting/receiving antenna 130, and the transmission line interface 140. The control section 110 may generate data to be transmitted as a signal, control information, a sequence, and the like, and may forward the data, the control information, the sequence, and the like to the transmission/reception section 120. The control section 110 may perform call processing (such as configuration or release) of a communication channel, management of the state of the base station 10, management of a radio resource, and the like.

The transmission/reception section 120 may include a baseband section 121, a radio frequency (RF) section 122, and a measurement section 123. The baseband section 121 may include a transmission processing section 1211 and a reception processing section 1212. The transmission/reception section 120 can be implemented by a transmitter/receiver, an RF circuit, a baseband circuit, a filter, a phase shifter, a measurement circuit, a transmission/reception circuit, and the like that are described based on common recognition in the technical field related to the present disclosure.

The transmission/reception section 120 may be configured as an integrated transmission/reception section or may be implemented by a transmission section and a reception section. The transmission section may be implemented by the transmission processing section 1211 and the RF section 122. The reception section may be implemented by the reception processing section 1212, the RF section 122, and the measurement section 123.

The transmitting/receiving antennas 130 can be implemented by antennas described based on common recognition in the technical field related to the present disclosure, for example, an array antenna.

The transmission/reception section 120 may transmit the above-described downlink channel, synchronization signal, downlink reference signal, and the like. The transmission/reception section 120 may receive the above-described uplink channel, uplink reference signal, and the like.

The transmission/reception section 120 may form at least one of a Tx beam or a reception beam by using digital beam forming (e.g., precoding), analog beam forming (e.g., phase rotation), and the like.

The transmission/reception section 120 (transmission processing section 1211) may perform packet data convergence protocol (PDCP) layer processing, radio link control (RLC) layer processing (e.g., RLC retransmission control), medium access control (MAC) layer processing (e.g., HARQ retransmission control), and the like, for example, on data or control information acquired from the control section 110 to generate a bit string to be transmitted.

The transmission/reception section 120 (transmission processing section 1211) may perform transmission processing such as channel coding (which may include error correction coding), modulation, mapping, filtering processing, discrete Fourier transform (DFT) processing (as necessary), inverse fast Fourier transform (IFFT) processing, precoding, or digital-analog conversion on the bit string to be transmitted and may output a baseband signal.

The transmission/reception section 120 (RF section 122) may perform modulation to a radio frequency band, filtering processing, amplification, and the like on the baseband signal and may transmit a signal in a radio frequency band via a transmitting/receiving antenna 130.

Meanwhile, the transmission/reception section 120 (RF section 122) may perform amplification, filtering processing, demodulation to a baseband signal, and the like on a signal in a radio frequency band received by a transmitting/receiving antenna 130.

The transmission/reception section 120 (reception processing section 1212) may apply, on the acquired baseband signal, reception processing such as analog-digital conversion, fast Fourier transform (FFT) processing, inverse discrete Fourier transform (IDFT) processing (as necessary), filtering processing, demapping, demodulation, decoding (which may include error correction decoding), MAC layer processing, RLC layer processing, or PDCP layer processing to acquire user data and the like.

The transmission/reception section 120 (measurement section 123) may perform measurement on the received signal. For example, the measurement section 123 may perform radio resource management (RRM), channel state information (CSI) measurement, and the like based on the received signal. The measurement section 123 may measure received power (e.g., reference signal received power (RSRP)), received quality (e.g., reference signal received quality (RSRQ), a signal to interference plus noise ratio (SINR), a signal to noise ratio (SNR)), signal strength (e.g., received signal strength indicator (RSSI)), propagation path information (e.g., CSI), and the like. The measurement result may be output to the control section 110.

The transmission line interface 140 may transmit/receive a signal (backhaul signaling) to and from an apparatus included in the core network 30, other base stations 10, and the like and may, for example, acquire or transmit user data (user plane data), control plane data, and the like for the user terminal 20.

Note that the transmission section and the reception section of the base station 10 in the present disclosure may be constituted by at least one of the transmission/reception section 120, the transmitting/receiving antenna 130, or the transmission line interface 140.

The transmission/reception section 120 may transmit a list including a plurality of path-loss reference signals (PL-RSs) (or a plurality of PL-RS candidates). In a case where none of the plurality of PL-RSs is in an activated state, the transmission/reception section 120 may receive an uplink signal for which path-loss calculation has been performed based on a specific PL-RS.

The transmission/reception section 120 may control scheduling of the uplink signal by using DCI including an SRS resource indicator field.

(User Terminal)

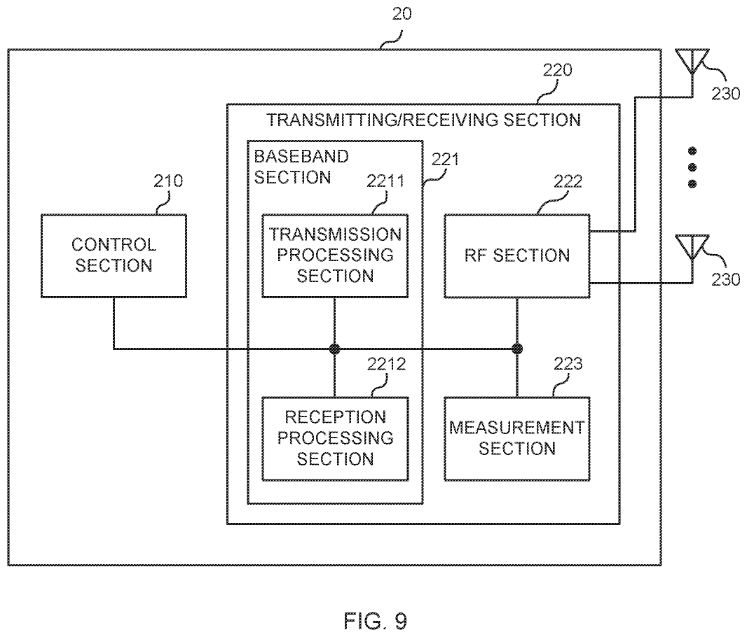

FIG. 9 is a diagram illustrating an example of a configuration of the user terminal according to one embodiment. The user terminal 20 includes a control section 210, a transmission/reception section 220, and a transmitting/receiving antenna 230. Note that one or more of the control sections 210, one or more of the transmission/reception sections 220, and one or more of the transmitting/receiving antennas 230 may be included.

Note that, although this example mainly describes functional blocks of a characteristic part of the present embodiment, it may be assumed that the user terminal 20 includes other functional blocks that are necessary for radio communication as well. A part of processing of each section described below may be omitted.

The control section 210 controls the entire user terminal 20. The control section 210 can be implemented by a controller, a control circuit, and the like that are described based on common recognition in the technical field related to the present disclosure.

The control section 210 may control signal generation, mapping, and the like. The control section 210 may control transmission/reception, measurement, and the like using the transmission/reception section 220 and the transmitting/receiving antenna 230. The control section 210 may generate data to be transmitted as a signal, control information, a sequence, and the like, and may forward the data, the control information, the sequence, and the like to the transmission/reception section 220.

The transmission/reception section 220 may include a baseband section 221, an RF section 222, and a measurement section 223. The baseband section 221 may include a transmission processing section 2211 and a reception processing section 2212. The transmission/reception section 220 can be implemented by a transmitter/receiver, an RF circuit, a baseband circuit, a filter, a phase shifter, a measurement circuit, a transmitting/receiving circuit, and the like that are described based on common recognition in the technical field related to the present disclosure.

The transmission/reception section 220 may be configured as an integrated transmission/reception section, or may be implemented by a transmission section and a reception section. The transmission section may be implemented by the transmission processing section 2211 and the RF section 222. The reception section may be implemented by the reception processing section 2212, the RF section 222, and the measurement section 223.

The transmitting/receiving antenna 230 can be implemented by an antenna that is described based on common recognition in the technical field related to the present disclosure, for example, an array antenna or the like.

The transmission/reception section 220 may receive the above-described downlink channel, synchronization signal, downlink reference signal, and the like. The transmission/reception section 220 may transmit the above-described uplink channel, uplink reference signal, and the like.

The transmission/reception section 220 may form at least one of a Tx beam or a reception beam by using digital beam forming (e.g., precoding), analog beam forming (e.g., phase rotation), and the like.

The transmission/reception section 220 (transmission processing section 2211) may perform PDCP layer processing, RLC layer processing (e.g., RLC retransmission control), MAC layer processing (e.g., HARQ retransmission control), and the like, for example, on data, control information, and the like acquired from the control section 210, to generate a bit string to be transmitted.

The transmission/reception section 220 (transmission processing section 2211) may perform transmission processing such as channel coding (which may include error correction coding), modulation, mapping, filtering processing, DFT processing (if necessary), IFFT processing, precoding, or digital-analog conversion on the bit string to be transmitted, to output a baseband signal.

Note that whether or not to apply DFT processing may be determined based on configuration of transform precoding. In a case where transform precoding is enabled for a certain channel (e.g., PUSCH), the transmission/reception section 220 (transmission processing section 2211) may perform DFT processing as the transmission processing in order to transmit the channel using a DFT-s-OFDM waveform. In a case where it is not the case, DFT processing need not be performed as the transmission processing.

The transmission/reception section 220 (RF section 222) may perform modulation to a radio frequency range, filtering processing, amplification, and the like on the baseband signal, to transmit a signal in the radio frequency range via the transmitting/receiving antenna 230.

Meanwhile, the transmission/reception section 220 (RF section 222) may perform amplification, filtering processing, demodulation to a baseband signal, and the like on the signal in the radio frequency range received by the transmitting/receiving antenna 230.

The transmission/reception section 220 (reception processing section 2212) may apply reception processing such as analog-digital conversion, FFT processing, IDFT processing (if necessary), filtering processing, demapping, demodulation, decoding (which may include error correction decoding), MAC layer processing, RLC layer processing, or PDCP layer processing on the acquired baseband signal to acquire user data and the like.

The transmission/reception section 220 (measurement section 223) may perform measurement on the received signal. For example, the measurement section 223 may perform RRM measurement, CSI measurement, and the like based on the received signal. The measurement section 223 may measure received power (e.g., RSRP), received quality (e.g., RSRQ, SINR, or SNR), signal strength (e.g., RSSI), propagation path information (e.g., CSI), and the like. The measurement result may be output to the control section 210.

Note that the transmission section and the reception section of the user terminal 20 in the present disclosure may include at least one of the transmission/reception section 220 or the transmitting/receiving antenna 230.

The transmission/reception section 220 may receive the list including the plurality of path-loss reference signals (PL-RSs).

In a case where none of the plurality of PL-RSs is in the activated state, the control section 210 may control the path-loss calculation by using a specific PL-RS for the uplink signal scheduled by the DCI including the SRS resource indicator field.

The specific PL-RS may be selected from the plurality of PL-RSs. Alternatively, the specific PL-RS may be selected from a list of configured transmission configuration indication (TCI) states. Alternatively, the specific PL-RS may be selected from at least one of the plurality of PL-RSs and the default PL-RS.

(Hardware Configuration)

Note that the block diagrams that have been used to describe the above embodiments illustrate blocks in functional units. These functional blocks (components) may be implemented in arbitrary combinations of at least one of hardware or software. Further, the method for implementing each functional block is not particularly limited. That is, each functional block may be implemented by a single apparatus physically or logically aggregated, or may be implemented by directly or indirectly connecting two or more physically or logically separate apparatuses (in a wired manner, a radio manner, or the like, for example) and using these apparatuses. The functional blocks may be implemented by combining software with the above-described single apparatus or the above-described plurality of apparatuses.

Here, the function includes, but is not limited to, determining, judging, calculating, computing, processing, deriving, investigating, searching, ascertaining, receiving, transmitting, outputting, accessing, solving, selecting, choosing, establishing, comparing, assuming, expecting, regarding, broadcasting, notifying, communicating, forwarding, configuring, reconfiguring, allocating, mapping, assigning, and the like. For example, a functional block (component) that has a transmission function may be referred to as a transmission section (transmitting unit), a transmitter, and the like. In any case, as described above, the implementation method is not particularly limited.

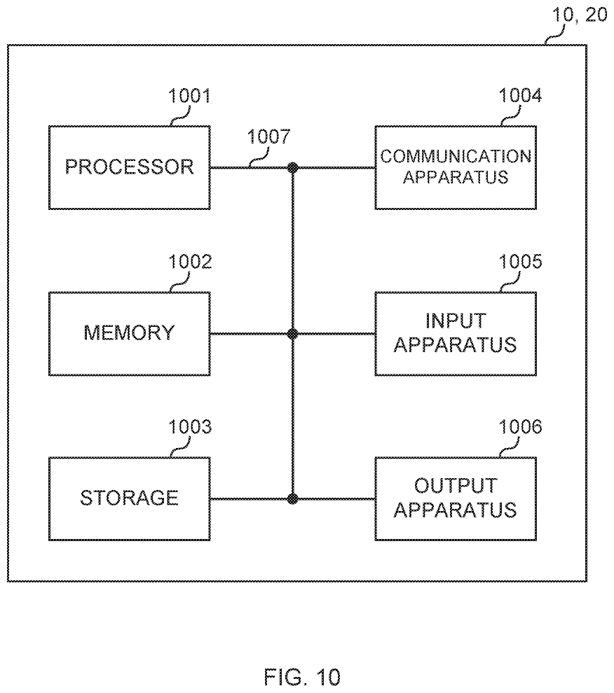

For example, the base station, the user terminal, and the like in one embodiment of the present disclosure may function as a computer that performs the processing of the radio communication method of the present disclosure. FIG. 10 is a diagram illustrating an example of a hardware configuration of the base station and the user terminal according to one embodiment. Physically, the above-described base station 10 and user terminal 20 may be formed as a computer apparatus that includes a processor 1001, a memory 1002, a storage 1003, a communication apparatus 1004, an input apparatus 1005, an output apparatus 1006, a bus 1007, and the like.

Note that in the present disclosure, the terms such as an apparatus, a circuit, a device, a section, and a unit can be read as interchangeable with each other. The hardware configuration of the base station 10 and the user terminal 20 may be designed to include one or more of the apparatuses illustrated in the drawings, or may be designed not to include some apparatuses.

For example, although only one processor 1001 is illustrated, a plurality of processors may be included. Further, the processing may be performed by one processor, or the processing may be performed by two or more processors simultaneously or sequentially, or using other methods. The processor 1001 may be implemented by one or more chips.

Each function of the base station 10 and the user terminal 20 is implemented by predetermined software (program) being read on hardware such as the processor 1001 and the memory 1002, by which the processor 1001 performs operations, controlling communication via the communication apparatus 1004, and controlling at least one of reading or writing of data at the memory 1002 and the storage 1003.

The processor 1001 controls the entire computer by, for example, operating an operating system. The processor 1001 may be configured by a central processing unit (CPU) including an interface with peripheral equipment, a control apparatus, an operation apparatus, a register, and the like. For example, at least a part of the above-described control section 110 (210), transmission/reception section 120 (220), and the like may be implemented by the processor 1001.

The processor 1001 reads programs (program codes), software modules, data, etc. from at least one of the storage 1003 or the communication apparatus 1004 into the memory 1002, and performs various types of processing according to these. As the program, a program that causes a computer to execute at least a part of the operation described in the above-described embodiment is used. For example, the control section 110 (210) may be implemented by control programs that are stored in the memory 1002 and that operate on the processor 1001, and other functional blocks may be implemented likewise.

The memory 1002 is a computer-readable recording medium, and may include, for example, at least one of a read only memory (ROM), an erasable programmable ROM (EPROM), an electrically EPROM (EEPROM), a random access memory (RAM), or other appropriate storage media. The memory 1002 may be referred to as a register, a cache, a main memory (primary storage apparatus), and the like. The memory 1002 can store programs (program codes), software modules, etc. that are executable for implementing the radio communication method according to one embodiment of the present disclosure.

The storage 1003 is a computer-readable recording medium, and may include, for example, at least one of a flexible disk, a floppy (registered trademark) disk, a magneto-optical disk (e.g., a compact disc ROM (CD-ROM) and the like), a digital versatile disk, a Blu-ray (registered trademark) disk), a removable disk, a hard disk drive, a smart card, a flash memory device (e.g., a card, a stick, or a key drive), a magnetic stripe, a database, a server, or other appropriate storage media. The storage 1003 may be referred to as a “secondary storage apparatus”.

The communication apparatus 1004 is hardware (transmission/reception device) for performing inter-computer communication via at least one of a wired network or a wireless network, and is referred to as, for example, a network device, a network controller, a network card, a communication module, and the like. The communication apparatus 1004 may include a high frequency switch, a duplexer, a filter, a frequency synthesizer, and the like in order to implement, for example, at least one of frequency division duplex (FDD) or time division duplex (TDD). For example, the transmission/reception section 120 (220), the transmitting/receiving antenna 130 (230), and the like described above may be implemented by the communication apparatus 1004. The transmission/reception section 120 (220) may be implemented by physically or logically separating the transmission section 120a (220a) and the reception section 120b (220b) from each other.

The input apparatus 1005 is an input device for receiving input from the outside (for example, a keyboard, a mouse, a microphone, a switch, a button, a sensor, and the like). The output apparatus 1006 is an output device that performs output to the outside (e.g., a display, a speaker, a light emitting diode (LED) lamp, or the like). Note that the input apparatus 1005 and the output apparatus 1006 may be an integrated configuration (e.g., touch panel).

The apparatuses such as the processor 1001 and the memory 1002 are connected by a bus 1007 for communicating information. The bus 1007 may be formed using a single bus, or may be formed using different buses for different connections between the apparatuses.

Further, the base station 10 and the user terminal 20 may include hardware such as a microprocessor, a digital signal processor (DSP), an application specific integrated circuit (ASIC), a programmable logic device (PLD), or a field programmable gate array (FPGA), and some or all of the functional blocks may be implemented by using the hardware. For example, the processor 1001 may be implemented using at least one of these pieces of hardware.

(Modifications)

Note that terms described in the present disclosure and terms necessary for understanding the present disclosure may be replaced with terms that have the same or similar meanings. For example, a channel, a symbol, and a signal (signal or signaling) may be read as interchangeable with each other. Further, the signal may be a message. The reference signal can be abbreviated as an RS, and may be referred to as a pilot, a pilot signal, and the like, depending on which standard applies. Further, a component carrier (CC) may be referred to as a cell, a frequency carrier, a carrier frequency, and the like.

A radio frame may be comprised of one or more periods (frames) in the time domain. Each of the one or more periods (frames) included in the radio frame may be referred to as a subframe. Further, the subframe may include one or more slots in the time domain. The subframe may be a fixed time duration (for example, 1 ms) that is not dependent on numerology.

Here, the numerology may be a communication parameter used for at least one of transmission or reception of a certain signal or channel. For example, the numerology may indicate at least one of subcarrier spacing (SCS), a bandwidth, a symbol length, a cyclic prefix length, a transmission time interval (TTI), the number of symbols per TTI, a radio frame configuration, specific filtering processing performed by a transceiver in the frequency domain, or specific windowing processing performed by a transceiver in the time domain.

The slot may include one or more symbols in the time domain (orthogonal frequency division multiplexing (OFDM) symbols, single carrier frequency division multiple access (SC-FDMA) symbols, and the like). Also, the slot may be a time unit based on numerology.

The slot may include a plurality of mini slots. Each mini slot may include one or more symbols in the time domain. Further, the mini slot may be referred to as a subslot. Each mini slot may include fewer symbols than the slot. A PDSCH (or PUSCH) transmitted in a time unit larger than the mini slot may be referred to as “PDSCH (PUSCH) mapping type A”. A PDSCH (or a PUSCH) transmitted using a mini slot may be referred to as PDSCH (PUSCH) mapping type B.

A radio frame, a subframe, a slot, a mini slot, and a symbol each represent a time unit in signal transmission. The radio frame, the subframe, the slot, the mini slot, and the symbol may be called by other applicable names, respectively. Note that time units such as a frame, a subframe, a slot, a mini slot, and a symbol in the present disclosure may be replaced with each other.

For example, one subframe may be referred to as TTI, a plurality of consecutive subframes may be referred to as TTI, or one slot or one mini slot may be referred to as TTI. That is, at least one of the subframe or the TTI may be a subframe (1 ms) in the existing LTE, may be a period shorter than 1 ms (e.g., one to thirteen symbols), or may be a period longer than 1 ms. Note that a unit representing a TTI may be referred to as a slot, a mini slot, or the like instead of a subframe.

Here, a TTI refers to, for example, a minimum time unit of scheduling in radio communication. For example, in the LTE system, a base station performs scheduling to allocate radio resources (a frequency bandwidth, transmit power, and the like that can be used in each user terminal) to each user terminal in TTI units. Note that the definition of a TTI is not limited to this.

A TTI may be a transmission time unit of a channel-coded data packet (transport block), a code block, a codeword, etc. or may be a processing unit of scheduling, link adaptation, etc. When a TTI is given, a time interval (e.g., the number of symbols) to which a transport block, a code block, a codeword, or the like is actually mapped may be shorter than the TTI.

When one slot or one mini slot is referred to as a TTI, one or more TTIs (that is, one or more slots or one or more mini slots) may be a minimum time unit of scheduling. The number of slots (the number of mini slots) constituting the minimum time unit of scheduling may be controlled.

A TTI having a time duration of 1 ms may be referred to as a usual TTI (TTI in 3GPP Rel. 8 to 12), a normal TTI, a long TTI, a usual subframe, a normal subframe, a long subframe, a slot, or the like. A TTI that is shorter than the usual TTI may be referred to as a shortened TTI, a short TTI, a partial TTI (or fractional TTI), a shortened subframe, a short subframe, a mini slot, a subslot, a slot, or the like.

A long TTI (such as a normal TTI or a subframe) may be replaced with a TTI having a duration exceeding 1 ms. A short TTI (such as a shortened TTI) may be replaced with a TTI having a TTI length less than the TTI length of a long TTI and more than or equal to 1 ms.

A resource block (RB) is the unit of resource allocation in the time domain and the frequency domain, and may include one or more contiguous subcarriers in the frequency domain. The number of subcarriers included in the RB may be the same regardless of the numerology, and may be twelve, for example. The number of subcarriers included in an RB may be determined based on a numerology.

An RB may include one or more symbols in the time domain, and may have a length of one slot, one mini slot, one subframe, or one TTI. One TTI, one subframe, etc. may each be comprised of one or more resource blocks.

Note that one or more RBs may be referred to as a physical resource block (PRB), a subcarrier group (SCG), a resource element group (REG), a PRB pair, an RB pair, and the like.

Furthermore, a resource block may include one or more resource elements (REs). For example, one RE may be a radio resource domain of one subcarrier and one symbol.

A bandwidth part (BWP) (which may be referred to as a partial bandwidth or the like) may represent a subset of contiguous common resource blocks (RBs) for a certain numerology in a certain carrier. Here, the common RB may be specified by the index of the RB based on a common reference point of the carrier. PRBs may be defined in a BWP and numbered within the BWP.

The BWP may include a BWP for UL (UL BWP) and a BWP for DL (DL BWP). For the UE, one or more BWPs may be configured within one carrier.

At least one of the configured BWPs may be active, and the UE does not have to expect transmission/reception of a predetermined signal/channel outside the active BWP. Note that “cell”, “carrier”, etc. in the present disclosure may be replaced with “BWP”.

Note that the structures of radio frames, subframes, slots, mini slots, symbols, and the like described above are merely examples. For example, configurations such as the number of subframes included in a radio frame, the number of slots per subframe or radio frame, the number of mini slots included in a slot, the number of symbols and RBs included in a slot or a mini slot, the number of subcarriers included in an RB, the number of symbols in a TTI, the symbol length, the length of cyclic prefix (CP), and the like can be variously changed.

The information, parameters, etc. described in the present disclosure may be represented using absolute values, or may be represented using relative values with respect to predetermined values, or may be represented using other corresponding information. For example, a radio resource may be specified by a predetermined index.

The names used for parameters etc. in the present disclosure are in no respect limiting. Furthermore, any mathematical expression or the like that uses these parameters may differ from those explicitly disclosed in the present disclosure. Since various channels (PUCCH, PDCCH, and the like) and information elements can be identified by any suitable names, various names allocated to these various channels and information elements are not restrictive names in any respect.

The information, signals, etc. described in the present disclosure may be represented using any of a variety of different technologies. For example, data, an instruction, a command, information, a signal, a bit, a symbol, a chip, etc., which may be referred to throughout the above description, may be represented by a voltage, a current, an electromagnetic wave, a magnetic field or a magnetic particle, an optical field or an optical photon, or any combination of these.

Information, signals, etc. can be output in at least one of a direction from a higher layer to a lower layer or a direction from a lower layer to a higher layer. Information, signals, etc. may be input and output via a plurality of network nodes.

Input and output information, signals, etc. may be stored in a specific location (e.g., memory), or may be managed using a control table. The information, signals, and the like to be input and output can be overwritten, updated, or appended. The output information, signals, and the like may be deleted. Information, signals, etc. that have been input may be transmitted to another apparatus.

Notification of information may be performed not only by using the aspects/embodiments described in the present disclosure but also using another method. For example, the notification of information in the present disclosure may be performed by using physical layer signaling (e.g., downlink control information (DCI) or uplink control information (UCI)), higher layer signaling (e.g., radio resource control (RRC) signaling, broadcast information (master information block (MIB)), system information block (SIB), or the like), or medium access control (MAC) signaling), another signal, or a combination thereof.

Note that the physical layer signaling may be referred to as Layer 1/Layer 2 (L1/L2) control information (L1/L2 control signal), L1 control information (L1 control signal), and the like. Further, the RRC signaling may be referred to as an RRC message, and may be, for example, an RRC connection setup message, an RRC connection reconfiguration message and the like. Further, notification of the MAC signaling may be performed using, for example, an MAC control element (CE).

Also, reporting of predetermined information (for example, reporting of information to the effect that “X holds”) does not necessarily have to be sent explicitly, and can be sent implicitly (for example, by not reporting this piece of information, by reporting another piece of information, and the like).

Determination may be performed using a value represented by one bit (0 or 1), or may be performed using a Boolean represented by true or false, or may be performed by comparing numerical values (e.g., comparison with a predetermined value).

Software, regardless of whether it is referred to as software, firmware, middleware, microcode, or a hardware description language, or referred to by another name, should be interpreted broadly to mean a command, a command set, a code, a code segment, a program code, a program, a subprogram, a software module, an application, a software application, a software package, a routine, a subroutine, an object, an executable file, an execution thread, a procedure, a function, etc.

Moreover, software, commands, information, and the like may be transmitted and received via communication media. For example, when software is transmitted from a website, a server, or another remote source by using at least one of a wired technology (coaxial cable, optical fiber cable, twisted pair, digital subscriber line (DSL), or the like) or a wireless technology (infrared rays, microwaves, and the like), at least one of the wired technology or the wireless technology is included within the definition of a transmission medium.

The terms “system” and “network” used in the present disclosure may be used interchangeably. The “network” may mean an apparatus (e.g., a base station) included in the network.

In the present disclosure, terms such as “precoding”, “precoder”, “weight (precoding weight)”, “quasi-co-location (QCL)”, “transmission configuration indication state (TCI state)”, “spatial relation”, “spatial domain filter”, “transmit power”, “phase rotation”, “antenna port”, “antenna port group”, “layer”, “number of layers”, “rank”, “resource”, “resource set”, “resource group”, “beam”, “beam width”, “beam angle”, “antenna”, “antenna element”, and “panel” can be used interchangeably.

In the present disclosure, terms such as “base station (BS)”, “radio base station”, “fixed station”, “NodeB”, “eNodeB (eNB)”, “gNodeB (gNB)”, “access point”, “transmission point (TP)”, “reception point (RP)”, “transmission/reception point (TRP)”, “panel”, “cell”, “sector”, “cell group”, “carrier”, and “component carrier”, can be used interchangeably. The base station may be referred to as a term such as a macro cell, a small cell, a femto cell, or a pico cell.

The base station can accommodate one or more (e.g., three) cells. In a case where the base station accommodates a plurality of cells, the entire coverage area of the base station can be partitioned into a plurality of smaller areas, and each smaller area can provide communication services through a base station subsystem (e.g., small base station for indoors (remote radio head (RRH))). The term “cell” or “sector” refers to a part or the whole of a coverage area of at least one of the base station or the base station subsystem that performs a communication service in this coverage.

In the present disclosure, the terms such as “mobile station (MS)”, “user terminal”, “user equipment (UE)”, and “terminal” can be used interchangeably.

The mobile station may be referred to as a subscriber station, mobile unit, subscriber station, wireless unit, remote unit, mobile device, wireless device, wireless communication device, remote device, mobile subscriber station, access terminal, mobile terminal, wireless terminal, remote terminal, handset, user agent, mobile client, client, or some other suitable terms.

At least one of the base station or mobile station may be called as a transmission apparatus, a reception apparatus, a wireless communication apparatus, and the like. Note that at least one of the base station or the mobile station may be a device mounted on a moving body, a moving body itself, and the like. The moving body may be a transportation (e.g., a car, an airplane, or the like), an unmanned moving body (e.g., a drone, an autonomous car, or the like), or a (manned or unmanned) robot. Note that at least one of the base station or the mobile station also includes an apparatus that does not necessarily move during a communication operation. For example, at least one of the base station or the mobile station may be an Internet of Things (IoT) device such as a sensor.

Further, the base station in the present disclosure may be read as interchangeable with the user terminal. For example, each aspect/embodiment of the present disclosure may be applied to a configuration in which communication between the base station and the user terminal is replaced with communication among a plurality of user terminals (which may be referred to as, for example, device-to-device (D2D), vehicle-to-everything (V2X), and the like). In this case, the user terminal 20 may have the function of the above-described base station 10. Further, terms such as “uplink” and “downlink” may be read as interchangeable with terms corresponding to communication between terminals (e.g., “side”). For example, an uplink channel, a downlink channel, etc. may be replaced with a side channel.

Likewise, a user terminal in the present disclosure may be replaced with a base station. In this case, the base station 10 may have the functions of the user terminal 20 described above.

In the present disclosure, an operation performed by the base station may be performed by an upper node thereof in some cases. In a network including one or more network nodes with base stations, it is clear that various operations performed for communication with a terminal can be performed by a base station, one or more network nodes (examples of which include but are not limited to mobility management entity (MME) and serving-gateway (S-GW)) other than the base station, or a combination thereof.

The aspects/embodiments illustrated in the present disclosure may be used individually or in combinations, which may be switched depending on the mode of implementation. Further, the order of processing procedures, sequences, flowcharts, and the like of the aspects/embodiments described in the present disclosure may be re-ordered as long as there is no inconsistency. For example, the methods described in the present disclosure have presented various step elements using an exemplary order, and are not limited to the presented specific order.

Each aspect/embodiment described in the present disclosure may be applied to a system using long term evolution (LTE), LTE-advanced (LTE-A), LTE-beyond (LTE-B), SUPER 3G, IMT-Advanced, 4th generation mobile communication system (4G), 5th generation mobile communication system (5G), 6th generation mobile communication system (6G), xth generation mobile communication system (xG) (xG (x is, for example, an integer or decimal), future radio access (FRA), new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), or another appropriate radio communication method, a next generation system expanded based on these, and the like. Further, a plurality of systems may be combined and applied (e.g., a combination of LTE or LTE-A and 5G, and the like).

The phrase “based on” as used in the present disclosure does not mean “based only on”, unless otherwise specified. In other words, the phrase “based on” means both “based only on” and “based at least on”.

All references to the elements using designations such as “first” and “second” as used in the present disclosure do not generally limit the amount or sequence of these elements. These designations can be used in the present disclosure, as a convenient way of distinguishing between two or more elements. Thus, references to first and second elements do not mean that only the two elements can be employed, or that the first element must precede the second element in some form.

The term “determining” as used in the present disclosure may include a wide variety of operations. For example, “determining” may be regarded as “determining” judging, calculating, computing, processing, deriving, investigating, looking up (or searching or inquiring) (for example, looking up in a table, database, or another data structure), ascertaining, and the like.

Furthermore, “determining” may be regarded as “determining” receiving (e.g., receiving information), transmitting (e.g., transmitting information), inputting, outputting, accessing (e.g., accessing data in memory), and the like.

Moreover, “determining” may be interpreted as “determining” resolving, selecting, choosing, establishing, comparing, and the like. That is, “determining” may be interpreted as “determining” some action.

In addition, “determining” may be replaced with “assuming”, “expecting”, “considering”, or the like.

The “maximum transmit power” described in the present disclosure may mean a maximum value of transmit power, a nominal UE maximum transmit power, or a rated UE maximum transmit power.

The terms “connected” and “coupled” used in the present disclosure, or any variation of these terms mean all direct or indirect connections or coupling between two or more elements, and may include the presence of one or more intermediate elements between two elements that are “connected” or “coupled” to each other. The coupling or connection between the elements may be physical, logical, or a combination of these. For example, “connection” may be replaced with “access”.

In the present disclosure, when two elements are connected together, it is conceivable that the two elements are “connected” or “coupled” to each other by using one or more electrical wires, cables, printed electrical connections, and the like, and, as some non-limiting and non-inclusive examples, by using electromagnetic energy having wavelengths in the radio frequency domain, microwave region, or optical (both visible and invisible) region, or the like.

In the present disclosure, the terms “A and B are different” may mean “A and B are different from each other”. Note that the phrase may mean that “A and B are different from C”. The terms such as “separate”, “coupled”, and the like may be interpreted similarly to “different”.

When “include”, “including”, and variations of these are used in the present disclosure, these terms are intended to be inclusive similarly to the term “comprising”. Moreover, the term “or” used in the present disclosure is intended to be not an exclusive-OR.

In the present disclosure, when articles are added by translation, for example, as “a”, “an”, and “the” in English, the present disclosure may include that nouns that follow these articles are plural.

In the above, the invention according to the present disclosure has been described in detail; however, it is obvious to those skilled in the art that the invention according to the present disclosure is not limited to the embodiments described in the present disclosure. The invention according to the present disclosure can be embodied with various corrections and in various modified aspects, without departing from the spirit and scope of the invention defined based on the description of claims. Consequently, the description of the present disclosure is provided only for the purpose of explaining examples, and should by no means be construed to limit the invention according to the present disclosure in any way.

1. A terminal comprising:
a reception section that receives a list including a plurality of path-loss reference signals (PL-RSs); and
a control section that controls path-loss calculation by using a specific PL-RS for an uplink signal scheduled by downlink control information (DCI) including a sounding reference signal (SRS) resource indicator field, in a case where none of the plurality of PL-RSs is in an activated state.

2. The terminal according to claim 1, wherein the specific PL-RS is selected from the plurality of PL-RSs.

3. The terminal according to claim 1, wherein the specific PL-RS is selected from a list of configured transmission configuration indication (TCI) states.

4. The terminal according to claim 1, wherein the specific PL-RS is selected from at least one of the plurality of PL-RSs and a default PL-RS.

5. A radio communication method comprising:
receiving a list including a plurality of path-loss reference signals (PL-RSs); and
controlling path-loss calculation by using a specific PL-RS for an uplink signal scheduled by downlink control information (DCI) including a sounding reference signal (SRS) resource indicator field, in a case where none of the plurality of PL-RSs is in an activated state.

6. A base station comprising:
a transmission section that transmits a list including a plurality of path-loss reference signals (PL-RSs);
a control section that schedules an uplink signal by using downlink control information (DCI) including a sounding reference signal (SRS) resource indicator field; and
a reception section that receives the uplink signal for which path-loss calculation has been performed based on a specific PL-RS in a case where none of the plurality of PL-RSs is in an activated state.
